(19) United States
(12) Patent Application Publication
(10) Pub. No.: US 2024/0273657 A1
(43) Pub. Date: Aug. 15, 2024

(54) SYSTEM AND METHOD FOR AUTOMATICALLY GENERATING RENEWAL OF LEASE CONTRACTS IN REAL ESTATE PROPERTIES

(71) Applicant: COLLEEN TECHNOLOGIES LTD, Petach Tikva (IL)

(72) Inventors: Ethan BAHIR, Petach Tikva (IL); Jonathan LASERSON, Ramat Gan (IL); Nir OSIROFF, Raanana (IL)

(73) Assignee: COLLEEN TECHNOLOGIES LTD, Petach Tikva (IL)

(21) Appl. No.: 18/436,215

(22) Filed: Feb. 8, 2024

Related U.S. Application Data
(60) Provisional application No. 63/484,289, filed on Feb. 10, 2023.

(51) Int. Cl. G06Q 50/163; G06Q 30/0202; G06Q 30/0645

(52) U.S. Cl. CPC G06Q 50/163; G06Q 30/0202; G06Q 30/0645

(57) ABSTRACT

Property managing firm's systems, methods and computer program products are provided, for automatically renewing property lease contracts. Ranking of tenants, units and applicants are derived and ranked with respect to all available information, and multiple models are implemented to derive the tenant likelihood of renewal and an unbiased tenant score; and a market estimator model estimating market demand. A determination unit is configured to integrate the derived parameters to order tenants and applicants by their quality scores and a contract generator engages the prospective new tenants.

### CROSS REFERENCE TO RELATED APPLICATIONS

This application claims priority from U.S. Provisional Application No. 63/484,289, filed on Feb. 10, 2023, which is incorporated herein by reference in its entirety.

### BACKGROUND OF THE INVENTION

### 1. Technical Field

The invention relates, in general, to the field of real estate rental management. More specifically, the invention relates to a system and method for automatically generating renewal of lease contracts in real estate properties. Additionally, the present invention relates to the field of communication systems, and more particularly, to AI (artificial intelligence)-based communication systems.

### 2. Discussion of Related Art

Property managers, for example, in the U.S., generally handle many properties and respective renting tenants. It is common for a single property manager to manage hundreds of properties and tenants simultaneously. Property managing firms handle even thousands of properties. Running so many apartments becomes very complicated in terms of lease renewals.

Data collected in the last decade shows that over 40% of the tenants in U.S. rented apartments do not renew their leases; they move out of their apartments when the lease expires.

For property managers, replacing tenants involves substantial working time and expenses; for example, due to the following causes: (1) Apartment inspection; (2) Repairing the apartment and preparing it for re-renting; (3) Re-advertising the apartment for rent, and showing the apartment to potential tenants; (4) The process of screening new applicants; (5) The cost of drafting a new contract; (6) Loss of rent during a period when the apartment is empty; and (7) Returning of the security deposit to the previous tenant upon clearance of all issues.

On the other hand, the manager may have a reason to prefer tenant replacement when a better lease agreement (such as a higher rent) is feasible or when a specific current tenant does not comply with the lease agreement.

The manager faces several significant challenges regarding the renewal of lease agreements, such as (1) understanding whether the existing tenant wishes to extend his stay, and if so, for how long; (2) deciding whether it is worthwhile to renew a specific tenant's lease agreement or perhaps prefer a new tenant; (3) the right time and the appropriate way to approach the tenant with a proposal for a new lease; (4) the optimal lease terms for the owner, e.g., increasing rent price.

These challenges create inefficiencies in the process of renewing lease agreements. To somewhat case the task, systems were introduced, mostly accounting and CRM (customer relationship management) software, specifically PM (property management) software systems such as Yardi and Realpage, assisting property managers in generating reports listing all the leases that are about to expire. Optionally, these systems are configured to send notifications in advance, allowing the manager to prepare a new lease on time. Existing systems also allow the creation of updated contracts based on predefined lease templates and the tenant's previous lease. However, this task is still tedious, time-consuming, and inefficient. The process is also highly based on the manager's subjective feelings, without precisely and independently evaluating and comparing existing tenants, considering and evaluating the market in terms of applications for new leases, and forecasting the results of tenant replacements for the coming year/s. Moreover, even if the manager contacts the tenant a reasonable time before the end of the lease, it doesn't mean the tenant will reply because the tenant is unsure if he wants to continue renting or because many tenants postpone their decisions or forget to answer. Most importantly, the renewal process is typically handled individually for each tenant and only upon necessity. Also, many non-renewal lease cases result from a lack of timely awareness by the tenants or the manager.

The situation becomes even more complicated, as a correct decision by the manager's side highly depends on the future market situation, specifically on the market situation in the coming months that have not yet arrived. In this situation, the manager has to forecast and evaluate the market in the coming months and include the future market evaluation in the possible renewal decision. Currently, the manager does not have an objective tool to advise him in this situation.

In-person negotiation of contracts is sometimes emotional and may unintentionally discriminate between candidates. In many cases, an automatic system that mitigates emotional states and biases is preferable for at least a part of the renewal task.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a property managing firm's system for automatically renewing property lease contracts, the system comprising: a tenants' and units' CRM (customer relationship management) configured to store units' occupancies, tenants' scores, and respective expiry date of each unit's contract; periodically issue a report detailing N units' contracts that are expected to expire within a predefined future period Tf; and submit to a determination unit a tenants' ranking, said tenants' ranking details a weighted score to each tenant residing at a unit within said report; an applicants' CRM configured to evaluate applications for units' lease received at the firm within a predefined past period Tp, and issue a predicted applicants' ranking list for the future period Tf, said applicants' ranking list details a weighted score to each past applicant in the list; and submit said applicants' ranking to said determination unit; a scoring model to provide tenant likelihood of renewal; and to provide an unbiased tenant score; a tenant demand model to provide with market model estimating demand; a determination unit configured to receive said report, said tenants' ranking, and said applicants' ranking, and possibly a number V of additional vacant units, and calculate population scores P for each number k, where k is a number between 0 to N; and from the highest population score P, selecting the respective k and defining this specific k as K, and submitting the K to a contract generator; a contract generator configured to receive the number K, and based on data from the tenants and unit CRM, automatically generates a contract to the K top tenants appearing at the tenants' ranking list; and a model providing an estimation of R—renewal acceptance rate and C—renewal conversion rate.

One aspect of the present invention provides a method of automatically renewing property lease contracts, comprising: receiving from a tenant CRM a report indicating the number N of units in which tenant contracts are about to expire within a predefined future period Tf; adding to this number, several units V already currently vacant; based on tenants' scores given during each tenant's stay in a respective unit, sorting from best to worst all tenants currently staying in these N units; for each number k between 1 to N, averaging the tenant scores, to obtain a series of tenant scores averages Q(k); analyzing application forms received during a past predefined period Tp, and sorting the applicants' scores based on applicant quality predefined criteria; averaging applicants' scores to receive M(g) for each possible number k=0, 1, . . . N, where g=(N+V−R*k)/C, thereby obtaining a series of application scores averages M(g); for each combination of tenants number k=(1 to N+V) determining M(g) (where g=(N+V−R*k)/C, and finding the respective value of the total population score P; selecting the highest P=R*k*Q(k)+(N−R*k+V)*M((N−R*k+V)/C) from all calculated population scores P, and selecting a value of K, K is the value of k in the maximally selected population score P; and automatically generating a renewed contract for each tenant appearing in the top K tenants in the sorted tenants' list; wherein C=a “conversion rate” is a constant between 0 and 1 measuring a probability of a new tenant with an approved application to sign a new lease contract presented to the tenant; and R=a “renewal acceptance rate” is a constant between 0 and 1, measuring the probability that an eligible tenant accepts a renewal contract presented to the tenant.

One aspect of the present invention provides a computer program product comprising a non-transitory computer readable storage medium having computer readable program embodied therewith, wherein the computer program product is associated with a property managing firm's system for automatically renewing property lease contracts, the computer readable program comprising: computer readable program configured to implement a renewal acceptance rate model that generates synthetic data and scenarios to simulate different renewal decisions, predicts patterns of tenant acceptance or non-renewal, and provides a renewal acceptance rate parameter R, computer readable program configured to implement a renewal conversion rate model that generates realistic profiles for a diverse range of applicants, simulates and predicts conversion rates by assessing how well applicants align with lease offerings, and provides a renewal conversion rate parameter C, computer readable program configured to implement a generative AI model to compute final tenants' scores, computer readable program configured to implement a predictive tenant demand model that estimates M(g)—the market input of the tenants' demands by analyzing, using a generative AI model—historical data, local economic indicators, and demographic trends to predict future demand for rental properties, simulating scenarios with respect to job market fluctuations, population growth, recession economic indicators, mortgage rates, neighboring properties vacancy, and prices; and provides an anticipated tenant demand, and computer readable program configured to implement a market estimator, which comprises: computer readable program configured to implement a tenant renewal likelihood analysis model that utilizes a generative AI model to analyze historical tenant data including payment history, past conversations, indicated renewal or moveout intent, and escalation in interaction, and predicts individual tenant likelihood for lease renewal, wherein the tenant renewal likelihood analysis model also provides an applicant ranking, and computer readable program configured to implement a generative AI model for unbiased evaluation of existing tenants to provide an objective quality assessment for unbiased evaluation of existing tenants aiding in optimal lease renewal decisions.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic block diagram of systems, according to some embodiments of the invention.

FIG. 2 is a high-level flowchart illustrating methods, according to some embodiments of the invention.

FIG. 3 provides experimental data comparing the errors of the disclosed predictive tenant demand model, according to some embodiments of the invention—compared to errors of manual estimation.

FIG. 4 is a high-level block diagram of exemplary controllers, which may be used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention provide efficient and economical methods and mechanisms for improved communication, enhanced by AI, and thereby provide improvements to the technological field of AI-based communication systems. Systems and methods are provided for improving communication with residents, increasing the effectiveness of renewing rent contracts and increasing renewal efficiency, by extensive implementation of machine learning within a structured correspondence model. In some embodiments, property managing firm's systems, methods and computer program products are provided, for automatically renewing property lease contracts. Ranking of tenants, units and applicants are derived and ranked with respect to all available information, and multiple models are implemented to derive the tenant likelihood of renewal and an unbiased tenant score; and a market estimator model estimating market demand. A determination unit is configured to integrate the derived parameters to order tenants and applicants by their quality scores and a contract generator engages the prospective new tenants.

As noted, property managers typically handle hundreds of tenants simultaneously. The renewal of contracts is relatively complicated, as, at the end of each month, tens (and sometimes hundreds) of renewals have to be handled, eventually ending with either contract renewals or contract terminations. The decision of whether to renew contracts and to whom is relatively complicated, as it depends on a variety of independent entities, such as (1) the tenant; (2) the property firm; and (3) predictions concerning the market, namely whether better tenants can be found to replace existing tenants.

Automatic methods and systems are provided for lease contract renewal. In general, given a list of all expiring contracts (e.g., within a predefined future period Tf, e.g., of two or three months), evaluation of the existing relevant tenants, evaluation of the market, including prediction concerning the “quality” of potentially replacing tenants, the system (1) determines an optimal tradeoff between (a) number of contract renewals and (b) termination of contracts and search for new tenants. For example, from among 60 end-of-lease contracts, plus six already vacant units, the system may conclude to renew 48 contracts and to look for 18 new tenants based on the evaluations of both the existing relevant tenants and applications for lease received at the property management within a past predefined period Tp of, e.g., three to four months. The evaluation of the recent applications includes both applications that matured into contracts and those that were not. In this manner, the system optimizes both revenue and the quality of tenants.

Given the system's conclusions concerning contract renewals, the system automatically generates new contracts for those found positive for a renewal. Finally, the system proceeds by automatically sending the generated contracts to each tenant, respectively.

Advantageously, disclosed management systems and methods automate apartment lease renewal by optimally deciding when and to whom to offer contract renewals. Moreover, disclosed systems and methods eliminate biasing and discrimination compared to the conventional handling of apartment lease renewals, by using objective automated algorithms. Finally, disclosed systems and methods automatically and systematically analyze the quality grades of existing tenants whose contracts are about to expire, and the quality grades of potential applicants, and advise the optimal tradeoff between contract renewals (of existing tenants) and assigning new prospective tenants.

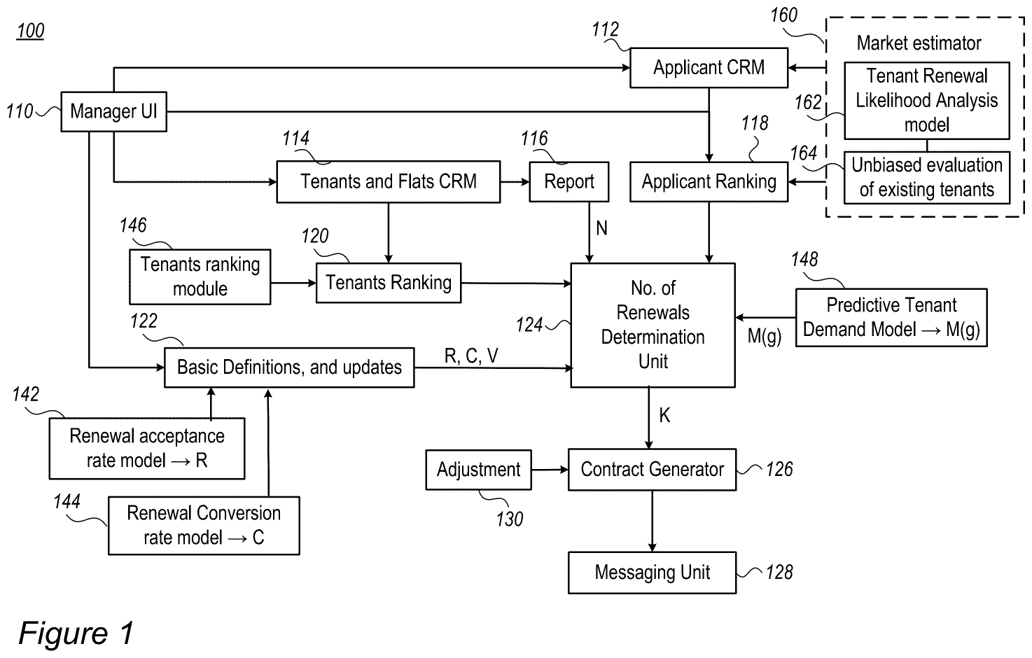

FIG. 1 is a high-level schematic block diagram of systems 100, according to some embodiments of the invention. Periodically (for example, every two to four weeks), the “tenants and units CRM” 114 (also referred to as “tenants CRM”) generates a report 116 listing lease contracts N that are supposed to expire within the next future period Tf (e.g., 2-3 months). Simultaneously, the “manager UI” 110 conveys several basic definitions 122, as defined by the property manager, for example: (i) R=the “renewal acceptance rate” (a constant between 0 to 1) measuring the probability that an eligible tenant accepts a renewal contract presented to the tenant; (ii) C=the “conversion rate”—a constant between 0 to 1 measuring the probability of a new tenant with an approved application to sign a new lease contract presented to the tenant; and (iii) V=The number of currently vacant units (apartments)—including both vacancies (empty units) and units whose tenants are not “eligible for renewal” or in a “will not renew” status. The property manager may update the values R, C, and V from time to time, and manager UI 110 may evaluate and suggest updates to R, C and V, e.g., on an ongoing basis. The property manager may also have access (via the manager UI) to report 116, to amend it when necessary.

A “Renewal acceptance rate model” 142 may be configured (e.g., as a computer-based module 142) to generate synthetic data and scenarios to simulate different renewal decisions, enabling the system to understand and predict patterns of tenant acceptance or non-renewal, returning a more accurate renewal acceptance rate parameter R. A “Renewal Conversion rate model” 144 may be configured (e.g., as a computer-based module 144) to generate realistic profiles for a diverse range of applicants, allowing the system to simulate and predict conversion rates by assessing how well applicants align with lease offerings, returning a more accurate renewal conversion rate parameter C. Both models 142, 144 may be implemented using machine learning (ML) and artificial intelligence (AI) algorithms to continuously improve the evaluation and updating of the parameters.

For simplicity, the description first considers a case where R=1, and C=1, namely, each selected tenant and applicant who receives a contract eventually signs it. The “renewals determination unit” 124 (hereinafter also referred to as the “determination unit”) also receives a list including the top N tenants' scores and ranking (“tenants ranking 120”), from tenants CRM 114. The tenants' scores are accumulated and updated by the property manager during the tenant's stay in the flat and generally reflect, for each user, their general “behavior” in fulfilling the contract and the flat regulations, based on, for example: the number of late payments; the debt to the firm; related neighbors' complaints; the number of claims the tenant had regarding property; etc. Each of the above issues may be grade-based, for example, between 1-5. Using the CRM model 114 and tenants' scores, a tenants ranking module 146 may use generative ML or AI models to compute the final tenant scores, continuously improve the evaluation and updating of the scores.

A “Predictive Tenant Demand Model” 148 may be configured (e.g., as a computer-based module 148) to estimate M(g)—the market input of the tenants' demands. Predictive tenant demand module 148 may use generative ML or AI models to compute the market demands, and continuously improve its estimations. For example, Predictive tenant demand module 148 may implement a generative AI model to analyze historical data, local economic indicators, and demographic trends to predict future demand for rental properties. The Model 148 can simulate various scenarios, considering factors such as job market fluctuations, population growth, recession economic indicators, mortgage rates, neighboring properties vacancy, and prices—to provide and update anticipated tenant demand.

After accumulating individual scores, the top N relevant tenants are ranked (sorted) from best to worst to form the tenants ranking 120. The tenants ranking 120 is conveyed to the determination unit 124. In addition, a sorted list reflecting the applicants' scores and ranking (applicants' ranking 118) may be fed into the determination unit 124. The applicants' ranking 118 may be based on recent applicants' filing rate and scores, for example, within a predefined past period Tp (e.g., in the last three months), and may be provided from the applicants' CRM 112. The applicant's scoring and ranking are based, for example, on the following parameters: Credit score; Criminal report; Previous eviction cases; Recommendations; Bank statements, etc.

Typically, the applicants' CRM 112 includes a market estimator 160 that may be configured (e.g., as a computer-based module 160) to calculate the applicants' ranking 118, in a manner described in more detail below. Estimator 160 may comprise a Tenant Renewal Likelihood Analysis model 162 that may be configured (e.g., as a computer-based module 162) to utilize Generative AI models to analyze historical tenant data (such as payment history, past conversations, indicated renewal or moveout intent, and escalation in interaction), and predicts individual tenant likelihood for lease renewal. Estimator 160 may further comprise a module 164 that may be configured (e.g., as a computer-based module 164) to derive an unbiased evaluation of existing tenants, e.g., implementing an objective quality assessment system employing generative AI for unbiased evaluation of existing tenants aiding in optimal lease renewal decisions. Market estimator 160, Tenant Renewal Likelihood Analysis module 162 and/or Unbiased Evaluation Module 164 may use generative ML or AI models to compute the respective parameters, and continuously improve their performance and accuracy.

By collecting and forming the above applicants' data and limiting the applicant ranking 118 to the recent period Tp, and given the distribution of applicant's grades and the application submission rate, the system estimates the future market quality, i.e., the quality of future applicants, if and when selected to fill available units. Different applicants predicted the system statistically calculates averages for different future periods. For example, a higher average will be received for the top-10 applicants for a future period of Tf1=months, than for Tf2=1 week, as from a collection of 1 month it is expected that a higher grade of applicants can be found. More specifically, the system determines a plurality of expected average scores for each varied number of applicants g. Given the final applicant's grading (limited, for example, to the next month), the average score decreases as the number of relevant applicants increases. For example, the average of the top 1 application (g=1), is surely higher than the average of N+V applications (g=N+V).

The applicant ranking 118 is also formed by incorporating results from the Generative AI-powered Tenant Renewal Likelihood Analysis module 162 that utilizes generative AI models to analyze historical tenant data (such as payment history, past conversations, indicated renewal or moveout intent, and escalation in interaction) and predicts individual tenant likelihood for lease renewal; as well as by incorporating results from the generative AI module 164 for unbiased evaluation of existing tenants—to aid in optimal lease renewal decisions using the derived unbiased evaluation of existing tenants.

Given all the above inputs, the determination unit 124 evaluates the input data and outputs a number K of tenants selected for contract renewals. Specifically, K tenants at the top of the tenants' ranking list 120 are selected for a contract renewal. As demonstrated below, the system optimizes the expected tenant population P for the next contract period. Given the number K, the rest of the expected vacancies (namely, N+V−R*K, where N is the number of contract expires in the period Tf, V is the additional currently vacant units, and R is the “renewal acceptance rate” defined above) will be filled by newly coming applicants. As the evaluation by the determination unit 124 has already considered the grades (specifically the average scores for each possible number g) of the recent applicants while considering their position on the applicants' list, the determination of the optimal K also optimizes the population P for the next period (for example, year) in terms of new applicants, if and when found from the given market. The defined population P includes the top R*K tenants that will receive a renewal contract for signing and N+V−R*K newly expected applicants, whose average grade is desired to be higher than those tenants excluded from contract renewal. In this regard, system 100 optimizes the population for the next contract period in all the available units.

For improved accuracy and a more practical situation, the following provides a non-limiting example, taking the “renewal acceptance rate” and the “conversion rate” C to be both different from 1. Accordingly, the determination unit 124 may operate as follows:
a. Finding M(g), namely, for k in {0, 1, 2, . . . , N} the system computes M(g), when g=N+V−R*k/C. A case when g=1 provides the highest “average”, namely the score of the top 1st applicant. A case when g=(N+V)/C provides the lowest average, namely the expected average score of the top G applicants that are expected in the future period Tf (for example, in the next 30 days) based on previous applicants (i.e., those who submitted applications to the property management company in the last Tp period);
b. Finding Q(k), namely a plurality of tenants averages for each possible k from 0 to N. A case when k=1 provides the highest “average”, namely the top 1 currently staying tenant score. A case when k=N provides the lowest average, namely the average score of the top N currently staying tenants;
c. Only R*k of the tenants who receive a new contract are expected to sign the contract eventually;
d. Hence N−R*k+V vacancies are expected;
e. Hence the firm needs to accept (N−R*k+V)/C applications to fill those vacancies;
f. The plurality of averages M(g) quality scores of those applications is computed as M((N−R*k+V)/C);
g. As a result, the expected tenants' population quality P may be computed as an optimized population score, e.g., in case of R=C=1, the system estimates the score as P=K*(Q(K))+G*(M(G)), where (Q(K)), provided by market estimator module 160, indicates the average of the top-graded selected K tenants who receive a contract for renewal. M(G)), provided by tenant's ranking model 120 as the average of the top-graded G applicants selected to complete residency of the rest of the units. Therefore, P reflects the highest combined score of the top selected K of “old” tenants who receive renewed contracts+top G new applicants as resulted from the determination of K. The value of K+G amounts to the total vacancies. More specifically, the Population score may be calculated as P=R*k*Q(k)+(N−R*k+V)*M((N−R*k+V)/C).

The population score P may be computed for each possible k between 0 to the total vacancies to find the k that provides the highest population score. This highest k is the K ouTput by the determination unit 124. Given this K, the contract generator 126 may be configured to generate renewed contracts to the K tenant on the top of the tenants ranking list 120. Their personal details are received from the tenants and units CRM 114. The rental price in the contract may be adjusted (for example, a 2% increase, 3% discount, etc.) by adjustment 130, based on the property manager's definitions.

Each generated contract may be automatically sent by messaging unit 128 to the respective tenant as an offer for signing. The property manager has to find the G new tenants to fill the remaining vacant units.

In some embodiments, disclosed property managing firm's system for automatically renewing property lease contracts, comprises: (A) tenants and units CRM configured to: (a) store units' occupancies, tenants' scores, and respective expiry date of each unit's contract; (b) periodically issue a report detailing N units' contracts that are expected to expire within a predefined future period Tf; (c) submit to a determination unit a tenants' ranking, said tenants' ranking details a weighted score to each tenant residing at a unit within said report; and (B) applicants CRM configured to: (d) evaluate applications for units' lease received at the firm within a predefined past period Tp, and issue a predicted applicants' ranking list for the future period Tf, said applicants' ranking list details a weighted score to each past applicant in the list; and (e) submit said applicants' ranking to said determination unit; (C) a determination unit configured to: (f) receive said report, said tenants ranking, and said applicants' ranking, and possibly a number V of additional vacant units, and calculate population scores P for each number k, where k is a number between 0 to N; and (g) from the highest population score P, selecting the respective k and defining this specific k as K, and submitting the K to a contract generator; (D) a contract generator configured to receive the number K, and based on data from the tenants and unit CRM, automatically generates a contract to the K top tenants appearing at the tenants' ranking list. The messaging unit may be configured to automatically send the generated contracts to the K tenants, based on respective tenants' addresses appearing at the tenants and units CRM. The highest population score P may be computed as the highest combination of: P=R*Q(k)+G*M(g), where Q(k) is the average score separately calculated for each k number of tenants, and M(g) is the average score separately calculated for each k number of applicants, and wherein said selected K is the k appearing within the highest population score P. The population score P may further consider R and C constants, wherein: (a) R is a constant between 0 to 1, defining a renewal acceptance rate measuring a probability that an eligible tenant accepts a renewal contract presented to the tenant; and (b) C is a constant between 0 to 1, defining conversion rate measuring a probability of a new tenant with an approved application to sign a new lease contract presented to the tenant. For example, the population score P may be computed as: P=R*k*Q(k)+(N−R*k+V)*M((N−R*k+V)/C). The applicant's weighted score may be evaluated from one or more of: (a) credit score; (b) criminal report; (c) eviction indication; (d) recommendations; and (c) bank statement. The weighted score of each tenant may be evaluated from one or more of: (a) number of late payments; (b) debt to the firm; (c) neighbors' complaints; (d) the number of claims the tenant had regarding the property. One or more parameters within the generated contracts may be predefined by a system manager of the firm. In certain embodiments R, Q(k), C, M(g) may be evaluated by predefined models, possibly deterministic models, economic models, statistical models and/or models based on machine learning or artificial intelligence as disclosed herein.

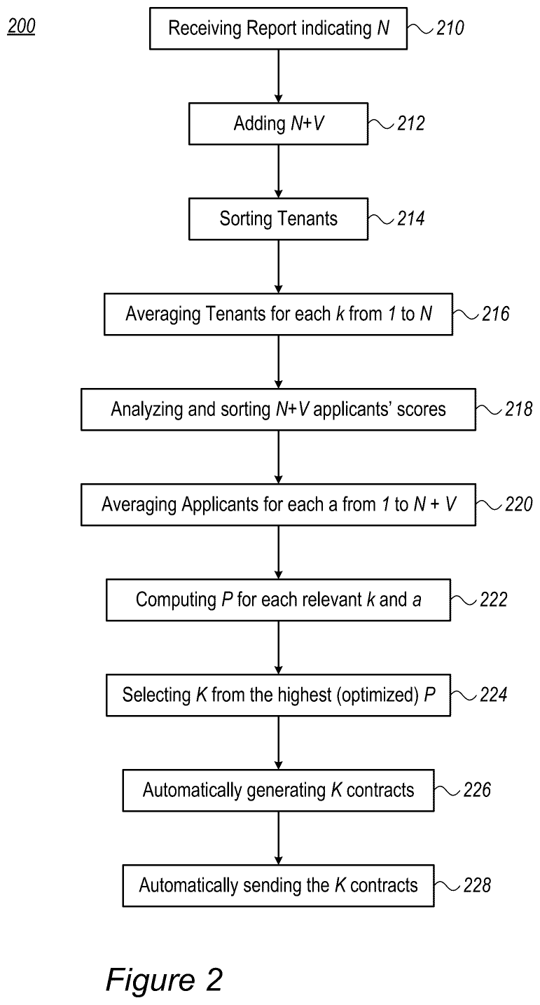

FIG. 2 is a high-level flowchart illustrating methods 200, according to some embodiments of the invention. The method stages may be carried out with respect to system 100 described above, which may optionally be configured to implement method 200. Method 200 may be at least partially implemented by at least one computer processor, e.g., in any of the disclosed modules. Certain embodiments comprise computer program products comprising a computer readable storage medium having computer readable program embodied therewith and configured to carry out the relevant stages of method 200. Method 200 may comprise the following stages, irrespective of their order.

Certain embodiments provide automatic methods 200 for lease contract renewal, e.g., for automatically renewing property lease contracts, which may include the following steps:
a. Receiving from a tenant CRM a report indicating the number N of units in which tenant contracts are about to expire within a predefined future period Tf (step 210);
b. Adding to this number the number of units V already currently vacant (step 212);
c. Based on tenants' scores given during the tenants' stays, sorting from best to worst all tenants currently staying in these N units (step 214);
d. For each number k between 0 to N, averaging the tenant scores, to obtain a series of tenant scores averages Q(k) (step 216).
e. Analyzing application forms received during a past predefined period Tp, sorting the applicants' scores based on applicant quality predefined criteria (step 218).
f. Averaging applicants' scores to receive M(g) for each possible number k=0, 1, . . . N, where g=(N+V−R*k)/C, thereby obtaining a series of application scores averages M(g) (step 220), (C denoting a “conversion rate” being a constant between 0 and 1 measuring a probability of a new tenant with an approved application to sign a new lease contract presented to the tenant; and R denoting a “renewal acceptance rate” being a constant between 0 and 1 measuring a probability that an eligible tenant accepts a renewal contract presented to the tenant);
g. For each combination of tenants number k=(1 to N+V) determining M(g) (where g=(N+V−R*k)/C, and finding the respective value of the total population score P (step 222); and
h. Selecting the highest P=R*k*Q(k)+(N−R*k+V)*M((N−R*k+V)/C) from all calculated population scores P, and selecting a value of K, K is the value of k in the maximally selected population score P (step 224); and
i. Automatically generating a renewed contract for each tenant appearing in the top K tenants in the sorted tenants' list. The renewed contract is based on the previous contract of the tenant, possibly with a price and/or a lease period adjustment (step 226); and
j. Automatically sending each contract to the respective tenant (step 228).

In the following, examples are provided to illustrate in a non-limiting manner the operation of disclosed systems and methods, according to some embodiments.

### Example 1

The following is an example for the operation of the market estimator 160. Given tenant applications to the properties during the past period Tp and an assessment of the applicants' “quality,” the system may estimate:
a) The distribution of the quality of the tenants who applied.
b) The rate by which tenants apply to the property.

Given the above estimations, the system may run statistical simulations (for example, V=10,000) over the quality scores to forecast the scores of the applications that are likely to be submitted to the property in the next month (Tf). Then, the system may calculate the mean quality score of the top g scores in each of the N simulations. The average of those N means is M(g).

If the system predicts that the market will provide in the next month less than g applicants, the list of scores may include Os for each “missing” applicant.

### Example 2

The following simple non-limiting numerical example illustrates the operation principles of disclosed systems and methods, according to some embodiments. Assuming that an apartment complex has ten units, five of them vacant and five with tenants whose lease is about to expire in the next month. The Tenants and units CRM 114 issues a tenants ranking 120, as follows: 10, 9, 8, 7, 6. Hence the average score of those five tenants is Q(5)=8.0.

If all five tenants receive a renewal contract, what will be the overall quality score of the tenants that will eventually reside in those ten units?

Assuming a probability of R=80% for a tenant to accept a renewal offer, only 5*80%=4 tenants would renew. Hence the property manager will have 1+5=6 vacancies to fill within the next month.

Assuming C=50% of the prospective tenants in the market who receive a lease offer eventually sign a new contract, it means that the property manager has to approach 12 tenants in the market to fill those six vacancies. Based on market statistics, the market estimator estimates the average quality score of those 12 applicants who will “receive” offers in the next month. So, the system queries the market estimator 160 for the expected average score of the top g=12 for the period Tf (in this example, one month), namely, the G predicted applicants at the top of the applicants' ranking 118. Let's assume that it predicts M(12)=8.2.

Then, the system calculates the population score P for each possible k from 1 to 10. For example, for K=4 tenants with an average score of 8.0, and 6 (new) tenants with an average score of 8.2. The overall combined score will be 81.2.

How would this number change if the property manager offered the renewal only to the top two existing tenants (with scores 10 and 9)? In that case, only 2*80%=1.6 tenants would renew, and therefore the property manager will have to provide offers to 8.4/50%=16.8 applicants from the market. Assuming that the determination unit 124 finds that M(16.8)=8.0, then the combined population score P is expected to be:

$$9.5 * 1.6 + 6.9 * 8.4 = 82.4$$

Hence, assuming that the determination unit 124 does not check for every k, the determination unit 124 concludes that K=2, namely, it is better to offer a renewal contract to the top two tenants rather than to all five tenants. Of course, in the preferable case, the determination unit 124 checks the population score P for all possible numbers of k between 0 to 5. It offers renewals to the number of tenants K, which yields the maximum population score P when evaluating in combination with the applicant's scores.

The above Example 2 has been simplified for the sake of clarity. As noted, a property management company handles hundreds, even thousands of units. As illustrated, the system of the invention applies the same principles to automate, at least partially, the contract renewal stage.

It should be noted that the calculation of the population score may give a higher weight to existing tenants compared to the new applicants to account for the costs and efforts involved in evacuating a unit and residing it with a new tenant.

As shown herein, the system of the invention significantly reduces the work of the property manager, as it automatically (a) first determines, based on the current market and evaluation of current tenants, an optimal tradeoff between the K renewal of contracts (to current top rated tenants) and new applicants; and (b) generate renewal contracts to the selected K tenants; and (c) sends the K renewed contracts to the selected K tenants.

### Example 3

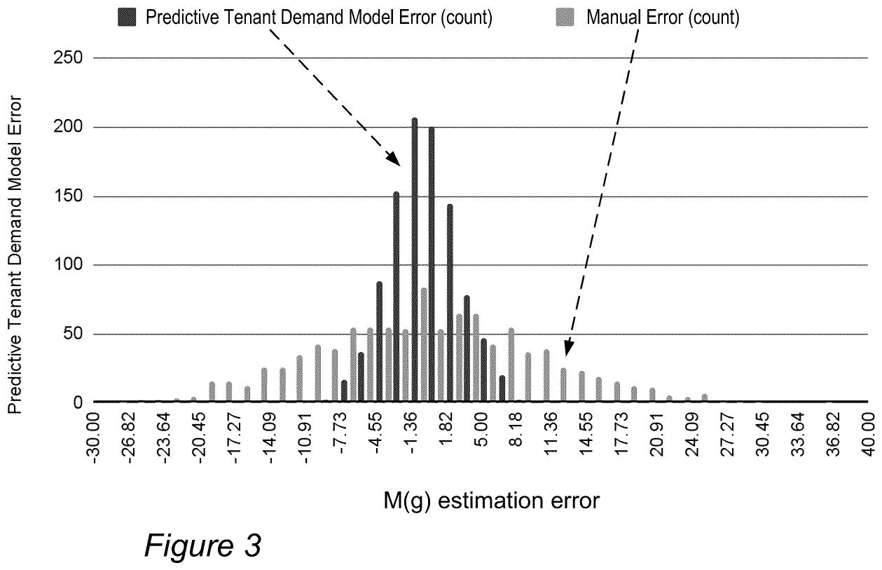

FIG. 3 provides experimental data comparing the errors of disclosed predictive tenant demand model 148, according to some embodiments of the invention—compared to errors of manual estimation. FIG. 3 illustrates the number of estimations in each error size category of M(g) estimation, measured against historical applicant data averaged over time and location. As shown in FIG. 3, market estimator 160 for predicting the tenant demand and deriving the parameter M(g) that quantifies the quality scores of the applications—reaches much smaller errors that manual estimation—due to the learning capacity of the ML/GI models over the large extents of available data—which are not feasible to be carried out manually and provide continuous improvements of the estimations.

### Example 4

Tables 1 and 2 provide a comparison between manual estimation and model estimation (by module 162 in market estimator 160) of the likelihood of tenant renewals, respectively—compared to a manual verification (denoted “Real Data”) derived by conversing with tenants up for renewals, and grading them on the same five-level likelihood scale of {None, Low, Mid, High, Certain}. The results were Manual Accuracy of 68.84% compared with Tenant Renewal Likelihood Analysis Model Accuracy of 90.68% —clearly indicating the significant improvement achieved using disclosed models.

TABLE 1
Manual estimation of the likelihood of tenant renewals.

| Manual | Real data | | | | |
|---|---|---|---|---|---|
| estimation | None | Low | Mid | High | Certain |
| None | 145 | 12 | 13 | 16 | 19 |
| Low | 17 | 146 | 15 | 19 | 17 |
| Mid | 11 | 16 | 144 | 14 | 13 |
| High | 10 | 22 | 11 | 117 | 13 |
| Certain | 20 | 16 | 22 | 15 | 135 |

TABLE 2
Model estimation of the likelihood of tenant renewals.

| Model | Real data | | | | |
|---|---|---|---|---|---|
| estimation | None | Low | Mid | High | Certain |
| None | 186 | 4 | 7 | 3 | 5 |
| Low | 8 | 192 | 6 | 5 | 9 |
| Mid | 3 | 6 | 183 | 2 | 2 |
| High | 3 | 6 | 5 | 170 | 7 |
| Certain | 3 | 4 | 4 | 1 | 174 |

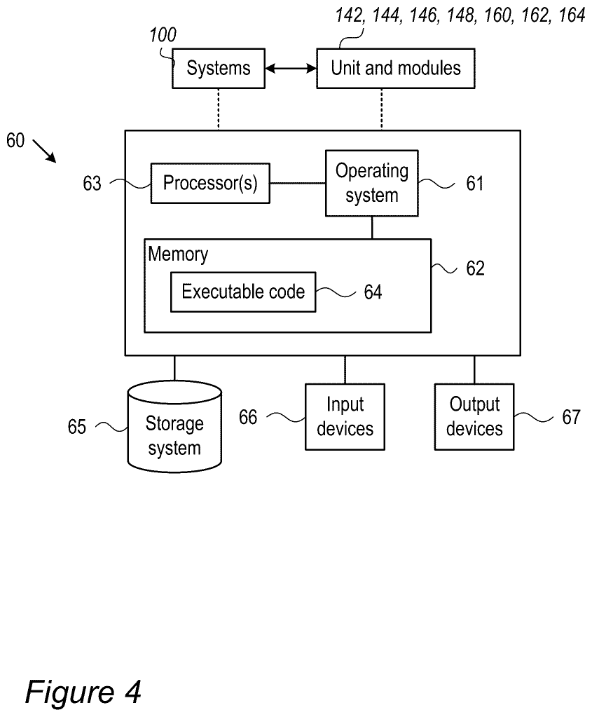

FIG. 4 is a high-level block diagram of exemplary controllers 60, which may be used with embodiments of the present invention. Any of systems 100, units or modules thereof (e.g., modules 142, 144, 146, 148, estimator 160 and/or modules 162, 164 thereof) as well as any of stages of methods 200 may be implemented using controllers 60 or parts thereof such as processor(s). Controller(s) 60 may include one or more controller or processor 63 that may be or include, for example, one or more central processing unit processor(s) (CPU), one or more Graphics Processing Unit(s) (GPU or general-purpose GPU—GPGPU), a field-programmable gate array (FPGA), an application-specific integrated circuit (ASIC), a digital signal processor (DSP), a microprocessor, a chip, a microchip, an integrated circuit (IC), or any other suitable multi-purpose or specific processor, controller or computational device, an operating system 61, a memory 62, a storage 65, input devices 66 and output devices 67.

Operating system 61 may be or may include any code segment designed and/or configured to perform tasks involving coordination, scheduling, arbitration, supervising, controlling, or otherwise managing operation of controller(s) 60, for example, scheduling execution of programs. Memory 62 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 60 may be used. Devices that include components similar or different to those included in controller(s) 60 may be used and may be connected to a network and used as a system. One or more processor(s) 63 may be configured to carry out embodiments of the present invention by for example executing software or code.

Storage 65 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 60 as shown by block 66. Output devices 67 may include one or more displays, speakers and/or any other suitable output devices. It will be recognized that any suitable number of output devices may be operatively connected to controller(s) 60 as shown by block 67. Any applicable input/ouTput (I/O) devices may be connected to controller(s) 60, for example, a wired or wireless network interface card (NIC), a modem, printer or facsimile machine, a universal serial bus (USB) device or external hard drive may be included in input devices 66 and/or ouTput devices 67.

Embodiments of the invention may include one or more article(s) (e.g., memory 62 or storage 65) such as a computer or processor non-transitory readable medium, or a computer or processor non-transitory storage medium, such as for example a memory as disclosed herein, a disk drive, or a USB flash memory, encoding, including or storing instructions, e.g., computer-executable instructions, which, when executed by a processor or controller, carry out methods disclosed herein.

Elements from FIGS. 1, 2 and 4 may be combined in any operable combination, and the illustration of certain elements in certain figures and not in others merely serves an explanatory purpose and is non-limiting.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A property managing firm's system for automatically renewing property lease contracts, the system comprising:
a tenants' and units' CRM (customer relationship management) configured to store units' occupancies, tenants' scores, and respective expiry date of each unit's contract; periodically issue a report detailing N units' contracts that are expected to expire within a predefined future period Tf; and submit to a determination unit a tenants' ranking, said tenants' ranking details a weighted score to each tenant residing at a unit within said report;
an applicants' CRM configured to evaluate applications for units' lease received at the firm within a predefined past period Tp, and issue a predicted applicants' ranking list for the future period Tf, said applicants' ranking list details a weighted score to each past applicant in the list; and submit said applicants' ranking to said determination unit;
a scoring model to provide tenant likelihood of renewal; and to provide an unbiased tenant score;
a tenant demand model to provide a market model estimating demand;
a determination unit configured to receive said report, said tenants' ranking, and said applicants' ranking, and possibly a number V of additional vacant units, and calculate population scores P for each number k, where k is a number between 0 to N; and from the highest population score P, selecting the respective k and defining this specific k as K, and submitting the K to a contract generator;
a contract generator configured to receive the number K, and based on data from the tenants and unit CRM, automatically generates a contract to the K top tenants appearing at the tenants' ranking list; and
a model providing an estimation of R—renewal acceptance rate and C—renewal conversion rate.

2. The system of claim 1, further comprising a messaging unit configured to automatically send the generated contracts to the K tenants, based on respective tenants addresses appearing at the tenants and units CRM.

3. The system of claim 1, wherein said highest population score P is computed as the highest combination of: P=R*Q(k)+G*M(g), where Q(k) is the average score separately calculated for each k number of tenants, and M(g) is the average score separately calculated for each k number of applicants, and wherein said selected K is the k appearing within the highest population score P.

4. The system of claim 3, wherein said highest population score P further considers R and C constants, wherein R is a constant between 0 to 1, defining a renewal acceptance rate measuring a probability that an eligible tenant accepts a renewal contract presented to the tenant; and C is a constant between 0 to 1, defining conversion rate measuring a probability of a new tenant with an approved application to sign a new lease contract presented to the tenant.

5. The system of claim 4, wherein said population score P is computed as P=R*k*Q(k)+(N−R*k+V)*M((N−R*k+V)/C), wherein R, Q(k), C, M(g) are evaluated by predefined models.

6. The system of claim 1, wherein said applicant's weighted score is evaluated from one or more of: a credit score; a criminal report; an eviction indication; recommendations; and a bank statement.

7. The system of claim 1, wherein said weighted score of each tenant is evaluated from one or more of: a number of late payments; a debt to the firm; neighbors' complaints; and a number of claims the tenant had regarding property.

8. The system of claim 1, wherein one or more parameters within the generated contracts are predefined by a system manager of the firm.

9. The system of claim 1, wherein the scoring model and/or the tenant demand model is implemented in a market estimator module configured to implement machine learning (ML) or artificial intelligence (AI) algorithms to provide the tenant likelihood of renewal and/or to provide the unbiased tenant score.

10. The system of claim 1, wherein and the determination unit comprises a respective module configured to implement ML or AI algorithms to determine the preferred tenants and applicants.

11. A method of automatically renewing property lease contracts, comprising:
a. receiving from a tenant CRM a report indicating the number N of units in which tenant contracts are about to expire within a predefined future period Tf;
b. adding to this number, several units V already currently vacant;
c. based on tenants' scores given during each tenant's stay in a respective unit, sorting from best to worst all tenants currently staying in these N units;
d. for each number k between 1 to N, averaging the tenant scores, to obtain a series of tenant scores averages Q(k);
e. analyzing application forms received during a past predefined period Tp, and sorting the applicants' scores based on applicant quality predefined criteria;
f. averaging applicants' scores to receive M(g) for each possible number k=0, 1, . . . N, where g=(N+V−R*k)/C, thereby obtaining a series of application scores averages M(g);
g. for each combination of tenants number k=(1 to N+V) determining M(g) (where g=(N+V−R*k)/C, and finding the respective value of the total population score P;
h. selecting the highest P=R*k*Q(k)+(N−R*k+V)*M((N−R*k+V)/C) from all calculated population scores P, and selecting a value of K, K is the value of k in the maximally selected population score P; and
i. automatically generating a renewed contract for each tenant appearing in the top K tenants in the sorted tenants' list,
wherein C=a “conversion rate” is a constant between 0 and 1 measuring a probability of a new tenant with an approved application to sign a new lease contract presented to the tenant; and R=a “renewal acceptance rate” is a constant between 0 and 1, measuring the probability that an eligible tenant accepts a renewal contract presented to the tenant.

12. The method of claim 11, wherein the renewed contract is based on the previous contract of the same tenant, respectively, possibly with a price and/or lease period adjustment.

13. The method of claim 11, further comprising automatically sending each contract to a respective tenant.

14. The method of claim 11, further comprising estimating the tenant likelihood of renewal using machine learning (ML) or artificial intelligence (AI) algorithms.

15. The method of claim 11, further comprising deriving the unbiased tenant score using ML or AI algorithms.

16. The method of claim 11, further comprising determining the preferred tenants and applicants using ML or AI algorithms.

17. A computer program product comprising a non-transitory computer readable storage medium having computer readable program embodied therewith, wherein the computer program product is associated with a property managing firm's system for automatically renewing property lease contracts, the computer readable program comprising:
computer readable program configured to implement a renewal acceptance rate model that generates synthetic data and scenarios to simulate different renewal decisions, predicts patterns of tenant acceptance or non-renewal, and provides a renewal acceptance rate parameter R,
computer readable program configured to implement a renewal conversion rate model that generates realistic profiles for a diverse range of applicants, simulates and predicts conversion rates by assessing how well applicants align with lease offerings, and provides a renewal conversion rate parameter C,
computer readable program configured to implement a generative AI model to compute final tenants' scores,
computer readable program configured to implement a predictive tenant demand model that estimates M(g)—the market input of the tenants' demands by analyzing, using a generative AI model—historical data, local economic indicators, and demographic trends to predict future demand for rental properties, simulating scenarios with respect to job market fluctuations, population growth, recession economic indicators, mortgage rates, neighboring properties vacancy, and prices; and provides an anticipated tenant demand, and
computer readable program configured to implement a market estimator, which comprises:
computer readable program configured to implement a tenant renewal likelihood analysis model that utilizes a generative AI model to analyze historical tenant data including payment history, past conversations, indicated renewal or moveout intent, and escalation in interaction, and predicts individual tenant likelihood for lease renewal, wherein the tenant renewal likelihood analysis model also provides an applicant ranking, and
computer readable program configured to implement a generative AI model for unbiased evaluation of existing tenants to provide an objective quality assessment for unbiased evaluation of existing tenants aiding in optimal lease renewal decisions.
